(19) United States
(12) Patent Application Publication
(10) Pub. No.: US 2020/0094581 A1
(43) Pub. Date: Mar. 26, 2020

(54) PRINTING APPARATUS

(71) Applicant: MIMAKI ENGINEERING CO., LTD., Nagano (JP)

(72) Inventor: Masaru OHNISHI, Nagano (JP)

(73) Assignee: MIMAKI ENGINEERING CO., LTD., Nagano (JP)

(21) Appl. No.: 16/568,228

(22) Filed: Sep. 11, 2019

(30) Foreign Application Priority Data
Sep. 20, 2018 (JP) 2018-175844

(51) Int. Cl. B41J 11/00

(52) U.S. Cl. CPC B41J 11/002

(57) ABSTRACT

A printing apparatus that performs a printing through an inkjet method is provided and includes: an inkjet head, and a heater. An ink contains an energy ray absorber and a solvent. The energy ray absorber is a substance that generates heat by absorbing an energy ray. The heater evaporates at least a part of the solvent in the ink by irradiating the ink with the energy ray. The ink contains, as at least a part of the solvent, a main solvent which is a component of a liquid that accounts for greater than or equal to 30% by weight ratio with respect to an entire of the ink. The main solvent is one or more mixtures selected from an organic solvent of normal paraffins, an organic solvent of isoparaffins, an organic solvent of naphthenes, an organic solvent of alkylbenzenes, and an organic solvent of olefins.

### CROSS REFERENCE TO RELATED APPLICATIONS

This application claims the priority benefit of Japanese Patent Application No. 2018-175844, filed on Sep. 20, 2018. The entirety of the above-mentioned patent application is hereby incorporated by reference herein and made a part of this specification.

### TECHNICAL FIELD

The present disclosure relates to a printing apparatus, a printing method, and an ink.

### DESCRIPTION OF THE BACKGROUND ART

Conventionally, an evaporation-drying type ink that fixes to a medium (media) by evaporating a solvent is widely used as an ink for an inkjet printer. Furthermore, in recent years, an ink (instant-drying type ink) in which the ink itself generates heat upon irradiation of energy rays such as ultraviolet light has been proposed as an evaporation type ink (see e.g., International Patent Publication No. 2017/135425, i.e., Patent Literature 1). In a case where such an instant-drying type ink is used, for example, the ink can be efficiently dried in a short time before smearing of ink (inter-color smearing, etc.) occurs by irradiating the ink on the medium with energy rays immediately after landing on the medium.

Patent Literature 1: International Patent Publication No. 2017/135425

### SUMMARY

However, the instant-drying type ink is a new type of ink developed in recent years. Therefore, it is desirable to advance research and development to a more preferable configuration for the configuration of the instant-drying type ink. The present disclosure thus provides a printing apparatus, a printing method, and an ink capable of overcoming such problem.

The inventors of the present application considered a preferable configuration with respect to the instant-drying type configuration from the standpoint of enhancing safety. Then, the inventors considered using a highly safe organic solvent or the like as a solvent (main solvent) of the ink. More specifically, solvent ink and the like which use an organic solvent as a main solvent have been widely used conventionally as an evaporation-drying type ink. Moreover, an organic solvent having a low boiling point and the like have been widely used as the main solvent of the solvent ink so that the ink can be dried in a short time. In addition, the organic solvent having a low boiling point used in conventional solvent ink is often subject to the organic solvent poisoning prevention rule (hereinafter referred to as organic law) defined by the Ministry of Health, Labor and Welfare of Japan. However, it is preferable to avoid the use of such organic solvents as much as possible in order to enhance the safety to the human body and the environment and to prevent the occurrence of problems on toxicity and the like more appropriately.

In this regard, in the conventional configuration, when the solvent ink is used, the smearing of ink easily occurs if the boiling point of the organic solvent used as the main solvent is high, and it may become difficult to perform high quality printing. In order to prevent the occurrence of the smearing of ink, it is also conceivable to increase the heating temperature of a heater (print heater) by using the heater that heats the medium at a position facing the inkjet head. However, in this case, the inkjet head is heated at the same time as the medium, and hence clogging of the nozzle of the inkjet head and the like easily occur. Furthermore, such a problem is particularly significant in a case where, for example, a multi-pass wide format printer (MWP) which performs large size and high definition printing in the field of sign graphics.

On the other hand, the inventors of the present application found through extensive research that, when an instant-drying type ink is used, printing can be performed more appropriately even when the boiling point of the organic solvent used as the main solvent is high. Furthermore, more specifically, the inventors found that, for example, even when a printed matter is produced in the field of sign graphics by the configuration of a multi-pass wide format printer, and the like, printing can be performed appropriately while suppressing the occurrence of smearing which becomes a problem. In this case, the inventors found that a safer organic solvent that does not fall under the organic law can be used as the organic solvent. Furthermore, through specific experiments, examinations, and the like, it was found that, for example, a liquid consisting of one or more mixtures selected from an organic solvent of normal paraffins, an organic solvent of isoparaffins, an organic solvent of naphthenes, an organic solvent of alkylbenzenes, and an organic solvent of olefins can be used as a main solvent containing such an organic solvent.

Furthermore, the inventors of the present application found the features necessary for obtaining such effects through further intensive research, and contrived the present disclosure. In order to solve the problems described above, the present disclosure provides a printing apparatus that performs a printing through an inkjet method, the printing apparatus including: an inkjet head that ejects an ink; and a heater that heats the ink ejected by the inkjet head; where the ink contains an energy ray absorber and a solvent, and the energy ray absorber is a substance that generates heat by absorbing an energy ray; the heater evaporates at least a part of the solvent in the ink by irradiating the ink with the energy ray; the ink contains, as at least a part of the solvent, a main solvent which is a component of a liquid that accounts for greater than or equal to 30% by weight ratio with respect to an entire of the ink; and the main solvent is one or more mixtures selected from an organic solvent of normal paraffins, an organic solvent of isoparaffins, an organic solvent of naphthenes, an organic solvent of alkylbenzenes, and an organic solvent of olefins.

With this configuration, an organic solvent with a small load on the human body and the environment can be appropriately used as a main solvent of the ink. Furthermore, in this case, the ink can be more appropriately dried even when using such an organic solvent by heating the ink by irradiation of energy rays. In this configuration, an organic solvent that does not fall under the organic law is preferably used as the organic solvent constituting the main solvent. With this configuration, for example, the safety of the ink can be more appropriately enhanced. Thus, for example, the printing performed using an instant-drying type ink can be more appropriately performed.

Here, in this configuration, the main solvent of the ink is, for example, a component having the largest weight ratio among the liquid components contained in the ink before being ejected from the inkjet head. Furthermore, the weight ratio of the main solvent with respect to the entire of the ink is preferably greater than or equal to 50%. The weight ratio of the main solvent with respect to the entire ink may be, for example, greater than or equal to 70% and the like. In addition, in this configuration, the ink may further contain a liquid component other than the main solvent.

As can be understood from the description made above, a mixed solvent including a plurality of organic solvents may be used as the main solvent. Furthermore, only one organic solvent may be used as the main solvent. In this case, it is conceivable to use, as the main solvent, any of an organic solvent of normal paraffins, an organic solvent of isoparaffins, an organic solvent of naphthenes, an organic solvent of alkylbenzenes, or an organic solvent of olefins.

In this configuration, the ink may further include, for example, a component same as or similar to a known ink. More specifically, the ink may further include, for example, a coloring material or the like corresponding to the color of the ink. Furthermore, as the energy ray absorber, for example, a dedicated substance may be used as the energy ray absorber, or another component (e.g., coloring material etc.) in the ink may also be given the function of the energy ray absorber. In the heater, evaporating at least a part of the solvent in the ink means, for example, volatilizing and removing the solvent in the ink so that the viscosity of the ink is increased to an extent that smearing does not occur. Furthermore, when referring to the smearing not occurring, this means, for example, that smearing that causes a problem in the quality required for printing does not occur for the ink landing on the medium to be printed.

More specifically, it is conceivable to use one or more mixtures selected from an organic solvent of isoparaffins, an organic solvent of naphthenes, and an organic solvent of alkylbenzenes as the main solvent of ink. Furthermore, the main solvent preferably contains, for example, an organic solvent having a boiling point of higher than or equal to 100° C. by greater than or equal to 50% by weight ratio with respect to the entire ink. Moreover, the main solvent further preferably contains, for example, an organic solvent having a boiling point of higher than or equal to 150° C. by greater than or equal to 50% by weight ratio with respect to the entire ink. With this configuration, the safety of the ink can be more appropriately improved. It is also conceivable to use, as the ink, for example, an ink further containing a binder resin which is a resin that remains on a medium to be printed even after drying of the ink. With this configuration, for example, the ink can be more appropriately fixed on the medium.

Moreover, in order to improve the safety of the ink, it is also conceivable to use, for example, an ink containing water as a main solvent. In this case, it is also conceivable to use a sub-solvent in addition to the main solvent as a component of the solvent. The sub-solvent is, for example, a component of a liquid having a smaller weight ratio than the main solvent of the components of the solvent of the ink. As the sub-solvent, it is conceivable to use one or more mixtures selected from, for example, an organic solvent of normal paraffins, an organic solvent of isoparaffins, an organic solvent of naphthenes, an organic solvent of alkylbenzenes, and an organic solvent of olefins. In this configuration as well, the safety of the ink can be appropriately improved.

Moreover, in order to improve the safety of the ink more appropriately, it is preferable to use a substance with higher safety also for the energy ray absorber and the like. More specifically, when using an ultraviolet light as the energy ray, it is conceivable to use, for example, a predetermined metal oxide or the like as the energy ray absorber. Moreover, as such a metal oxide, it is conceivable to use, for example, one or more substances selected from ZnO, TiO₂, CeO₂, and Fe₂O₃. Moreover, in this case, among these, it is particularly preferable to use ZnO as an energy ray absorber. With this configuration, for example, the safety of the ink can be more appropriately enhanced.

When using a highly safe ultraviolet light absorber, it may be possible to use a printing apparatus for more various applications by, for example, using a solvent with a sufficiently small load on the human body. In this case, for example, consideration is made to perform printing on a food by the printing apparatus. Furthermore, in a case of applications where high safety is particularly required, such as a food, it is preferable to use water as the main solvent of the ink rather than the organic solvent. In addition to the food, for example, printing in the field of a food packaging, toys, clothing, and the like may be considered.

Use of a printing method and an ink having the features similar to above, and the like can be considered for the configuration of the present disclosure. In this case as well, for example, effects similar to the above can be obtained. Furthermore, in this case, the printing method can be considered as, for example, a manufacturing method for a printed matter.

According to the present disclosure, printing performed using an instant-drying type ink can be more appropriately performed.

### BRIEF DESCRIPTION OF THE DRAWINGS

FIGS. 1A and 1B are views showing an example of a configuration of a printing apparatus 10 according to one embodiment of the present disclosure. FIGS. 1A and 1B are respectively a top view and a side cross-sectional view showing an example of a configuration of a main part of the printing apparatus 10 in a simplified manner.

FIGS. 2A and 2B are views describing a modified example of a configuration of the printing apparatus 10. FIGS. 2A and 2B are respectively a side cross-sectional view and a top view showing an example of a configuration of a main part of the printing apparatus 10 in the present modified example in a simplified manner.

FIGS. 3A and 3B is a view describing features of using an instant-drying type ink in more detail. FIG. 3A is a view schematically showing an operation of drying the instant-drying type ink. FIG. 3B is a cross-sectional view showing an example of a state of a medium 50 after the printing is completed.

### DESCRIPTION OF EMBODIMENTS

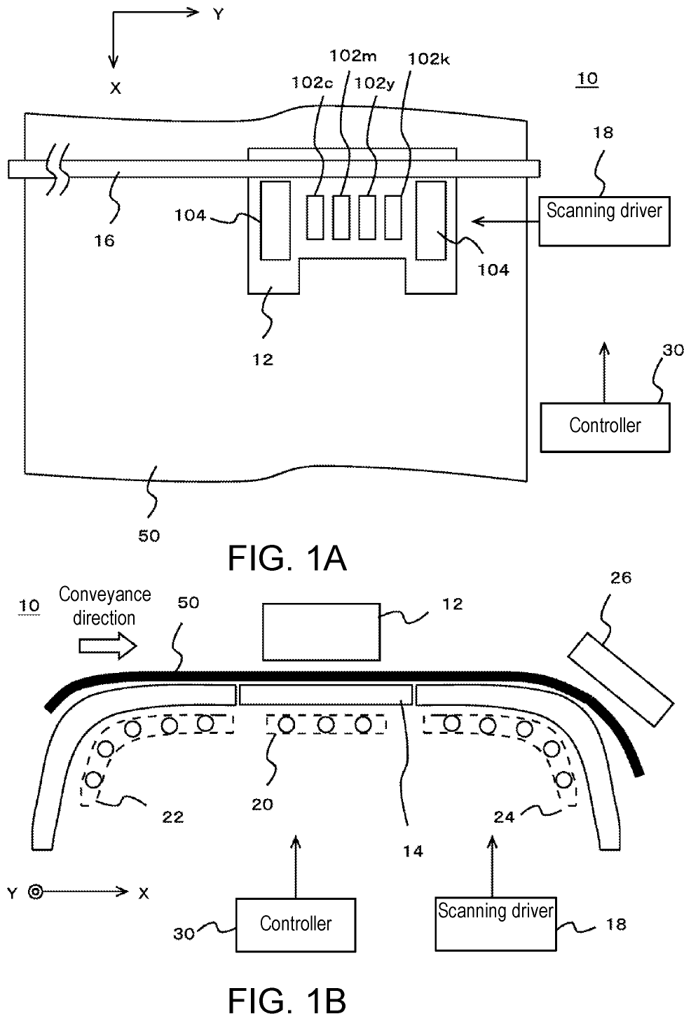

Hereinafter, an embodiment according to the present disclosure will be described with reference to the drawings. FIGS. 1A and 1B show one example of a printing apparatus 10 according to one embodiment of the present disclosure. FIGS. 1A and 1B are respectively a top view and a side cross-sectional view showing an example of a configuration of a main part of the printing apparatus 10 in a simplified manner. Note that, other than the points described below, the printing apparatus 10 may have features same as or similar to the known printing apparatuses. For example, in addition to the configurations described below, the printing apparatus 10 may further include various configurations same as or similar to the known printing apparatuses.

In the present example, the printing apparatus 10 is an inkjet printer (color inkjet printer) that performs printing through an inkjet method on a medium (media) 50 to be printed, and includes a head portion 12, a platen 14, a guide rail 16, a scanning driver 18, a print heater 20, a preheater 22, an after-heater 24, an infrared heater 26, and a controller 30. The head portion 12 is a part (IJ head portion) that ejects ink to the medium 50, and includes a plurality of inkjet heads and a plurality of ultraviolet light sources 104. More specifically, in the present example, as shown in FIG. 1A, the head portion 12 includes, as a plurality of inkjet heads, an inkjet head 102c, an inkjet head 102m, an inkjet head 102y, and an inkjet head 102k (hereinafter referred to as inkjet heads 102c to k). The inkjet heads 102c to 102k are examples of ejection heads, and eject color ink (colored ink) of each color for color printing. More specifically, the inkjet head 102c ejects ink of cyan color (C color). The inkjet head 102m ejects ink of magenta color (M color). The inkjet head 102y ejects ink of yellow color (Y color). The inkjet head 102k ejects ink of black color (K color). Furthermore, each of the inkjet heads 102c to 102k has a plurality of nozzles for ejecting ink onto a surface (nozzle surface) facing the medium 50. Moreover, in the present embodiment, the plurality of nozzles in each of the inkjet heads 102c to 102k are arranged in a nozzle row direction parallel to an X direction set in advance in the printing apparatus 10. Furthermore, as shown in the figure, the inkjet heads 102c to 102k are arranged in a Y direction orthogonal to the X direction with the positions in the X direction aligned. In this case, the X direction is a direction parallel to the sub scanning direction in which the head portion 12 is moved relative to the medium 50 at the time of sub scan to be described later. The Y direction is a direction orthogonal to the X direction. Further, in the present example, the Y direction is a direction parallel to the main scanning direction in which the head portion 12 is moved relative to the medium 50 at the time of main scan. The main scan refers to, for example, an operation of ejecting ink while moving in the main scanning direction.

Furthermore, in the present example, an evaporation-drying type ink is used as the ink (color ink) ejected from the inkjet heads 102c to 102k. More specifically, an instant-drying type ink is used as the evaporation-drying type ink. The instant-drying type ink is an ink in which the ink itself generates heat by irradiation of energy rays. When the ink itself generates heat by irradiation of the energy rays, this means that, for example, any component in the ink absorbs the energy ray so that the temperature of the entire ink rises. In a case where such an instant-drying type ink is used, for example, the ink can be appropriately dried in a short time by irradiating the ink attached to the medium 50 with energy rays. Furthermore, for example, the ink can be appropriately dried before smearing of ink occurs. More specifically, in the present example, an ink which contains an ultraviolet light absorber and a solvent and in which the ink itself generates heat by irradiation of ultraviolet light, which is an example of energy rays, is used as the evaporation-drying type ink. Furthermore, the color ink to be used in the present example further includes a coloring material corresponding to the color of the ink.

In this case, the ultraviolet light absorber is an example of an energy ray absorber which is a substance that generates heat by absorbing energy rays. The solvent is, for example, a liquid that dissolves or disperses other components in the ink. The solvent can be considered, for example, as a liquid used as a main component of the ink. The main component of the ink is, for example, the component contained in the ink in the largest weight ratio. Furthermore, the instant-drying type ink can also be considered as, for example, an ink that converts energy of the ultraviolet light and the like into heat energy. Moreover, for example, a pigment and the like can be suitably used as a coloring material of an ink. It is also conceivable to use a dye and the like, for example, as a coloring material. The features of the ink to be used in the present example will be described in more detail later.

The plurality of ultraviolet light sources 104 in the head portion 12 are ultraviolet irradiators (UV LED irradiators) that generate ultraviolet light for causing the ink to generate heat. Furthermore, in the present example, the plurality of ultraviolet light sources 104 are an example of a heater that heats the ink after being ejected by the inkjet head, and are arranged on one side and the other side in the Y direction with respect to the arrangement of the inkjet heads 102c to 102k so that at least some positions overlap the inkjet heads 102c to 102k in the X direction. Thus, the ultraviolet light source 104 irradiates the ink attached to the medium 50 with the ultraviolet light immediately after landing (immediately after inkjet printing) at the time of each main scan. The irradiation of the ultraviolet light by the ultraviolet light source 104 is preferably uniform at least in a range of a width (ejection width) in the sub scanning direction of a range in which the ink is ejected in the same main scan (pass). Furthermore, in the present example, the head portion 12 performs a bidirectional (two-way) main scan in one and the other directions in the main scanning direction. In this case, among the plurality of ultraviolet light sources 104 in the head portion 12, the ultraviolet light source 104 on the back side of the inkjet heads 102c to 102k in the moving direction of the head portion 12 irradiates the ink on the medium 50 with the ultraviolet light. With such a configuration, for example, the viscosity of the ink can be sufficiently increased before ink smearing occurs by irradiating the ink immediately after landing on the medium 50 with an ultraviolet light. A light source that can be on/off controlled is preferably used as the ultraviolet light source 104. Furthermore, in the present example, an UV LED which is an LED that generates an ultraviolet light is used as the ultraviolet light source 104.

In the present example, the ultraviolet light source 104 evaporates at least a part of the solvent in the ink by irradiating the ink on the medium 50 with an ultraviolet light. In this case, evaporating at least a part of the solvent in the ink means, for example, volatilizing and removing the solvent in the ink so that the viscosity of the ink is increased to an extent smearing does not occur. When smearing does not occur, this means for example, that smearing which becomes a problem in the quality required for printing does not occur in the ink that landed on the medium 50.

The platen 14 is a table-shaped member that supports the medium 50, and supports the medium 50 so as to face the head portion 12. Furthermore, in the present example, the platen 14 interiorly accommodates the print heater 20, the preheater 22, and the after-heater 24 therein. The guide rail 16 is a rail member that guides the movement of the head portion 12 at the time of main scan.

The scanning driver 18 is a driver that causes the head portion 12 to perform the main scan and the sub scan. In this case, causing the head portion 12 to perform the main scan and the sub scan means causing the inkjet head in the head portion 12 to perform the main scan and the sub scan. At the time of the main scan, for example, the scanning driver 18 causes each inkjet head of the head portion 12 to eject ink according to an image to be printed while moving the head portion 12 along the guide rail 16. Furthermore, in the present example, the scanning driver 18 causes the head portion 12 to perform the bidirectional main scan.

Furthermore, the scanning driver 18 changes the region facing the head portion 12 in the medium 50 by performing the drive of the sub scan between the main scans. In this case, the sub scan is, for example, an operation of relatively moving with respect to the medium 50 in the sub scanning direction. The scanning driver 18 performs the drive of the sub scan by driving, for example, a roller (not shown) and moving the medium 50 in the conveyance direction parallel to the sub scanning direction.

The print heater 20 is a heater that heats the medium 50 at a position facing the head portion 12. For example, the ink on the medium 50 can be more efficiently heated by using the print heater 20. Furthermore, in this case, the configuration of the printing apparatus 10 of the present example can be considered as a configuration of drying the ink using both the ultraviolet light source 104 and the print heater 20. The print heater 20 can also be considered as, for example, a second heater that heats the back surface of the medium 50 in the vicinity of the printing position.

When the heating temperature of the print heater 20 is high, the problems of nozzle clogging and the like easily occur as for example, the inkjet head in the head portion 12 is heated. In this case, the nozzle clogging is, for example, the clogging of the nozzle in the inkjet head due to the drying of ink. Therefore, the heating temperature by the print heater 20 is preferably lower than or equal to 60° C. Furthermore, in the present example, as described above, the ink can be efficiently heated using the ultraviolet light source 104 or the like. Therefore, the heating temperature by the print heater 20 is more preferably set to a sufficiently low temperature for the purpose of suppressing the influence of the environmental temperature and making the temperature of the medium 50 constant. In this case, for example, the print heater 20 heats the entire medium 50 (entire region facing the print heater 20) at a temperature (e.g., about lower than or equal to 50° C.) closer to room temperature. The heating temperature of the medium 50 by the print heater 20 is preferably lower than or equal to 40° C., and more preferably lower than or equal to 30° C. According to this configuration, for example, the influence of the environmental temperature and the like can be appropriately suppressed while suppressing the problems such as the nozzle clogging.

The preheater 22 is a heater that heats the medium 50 on the upstream side of the head portion 12 in the conveyance direction. The initial temperature of the medium 50 can be appropriately adjusted before reaching the position of the head portion 12 by using the preheater 22. In this case, the heating temperature of the medium 50 by the preheater 22 is preferably also a sufficiently low temperature (e.g., lower than or equal to 50° C., preferably lower than or equal to 40° C., and more preferably lower than or equal to 35° C.) for the purpose of suppressing the influence of the environmental temperature.

The after-heater 24 is a heater that heats the medium 50 on the downstream side of the head portion 12 in the conveyance direction. The after-heater 24 can also be considered, for example, as a post-dryer for promoting drying, a post-heating heater for completely drying the ink on the medium 50, or the like. For example, the ink can be more reliably dried before the printing is completed by using the after-heater 24. The heating temperature of the medium 50 by the after-heater 24 is assumed to be, for example, about 30 to 50° C. The heating temperature of the after-heater 24 may be set to a certain high temperature within a range of lower than or equal to a heat resistant temperature of the medium 50 to use.

Furthermore, the incomplete drying can be appropriately prevented from occurring even when, for example, printing is performed at high speed by using the after-heater 24. Moreover, for example, even in a case where the medium 50 to be wound after printing is used, and the like, the offset and the like at the time of winding can be appropriately prevented. When the medium 50 to be wound up after printing is used, the after-heater 24 is disposed between a winding device that winds the medium 50 and the head portion 12. In this case, the after-heater 24 can be considered as, for example, a third heater or the like that performs heating later than the ultraviolet light source 104 and the print heater 20.

The infrared heater 26 is a heater (infrared drying heater) that heats the medium 50 by irradiating an infrared ray. For example, an infrared light source or the like that generates an infrared ray including far infrared ray can be suitably used as the infrared heater 26. Furthermore, in the present example, the infrared heater 26 heats the medium 50 together with the after-heater 24 on the downstream side of the head portion 12 in the conveyance direction. The infrared heater 26 can also be considered as, for example, a post-heating heater using an infrared ray. In the present example, as shown in the figure, the infrared heater 26 heats the medium 50 from the side opposite to the after-heater 24 by being disposed at a position facing the after-heater 24 with the medium 50 therebetween. Thus, the infrared heater 26 irradiates the infrared ray toward the surface of the medium 50 to which the ink is attached. The ink can be more reliably dried before the printing is completed by using the infrared heater 26.

As described above, in the present example, the ink is dried using the ultraviolet light source 104 or the like. In this case, the anti-smearing and drying with respect to the layer of ink are mainly performed by irradiation of an ultraviolet light by the ultraviolet light source 104 or the like. Therefore, depending on the environment in which the printing apparatus 10 is used and the required printing quality, some or all of the print heater 20, the preheater 22, the after-heater 24, and the infrared heater 26 may be omitted. Furthermore, it is conceivable to use various known heater as the print heater 20, the preheater 22, and the after-heater 24. More specifically, for example, a heat transfer heater, a warm air heater or the like can be suitably used as the print heater 20, the preheater 22, and the after-heater 24. Furthermore, it is also conceivable to use an infrared heater as the print heater 20, the preheater 22, and the after-heater 24. Moreover, in the present example, the print heater 20, the preheater 22, the after-heater 24, and the infrared heater 26 can be considered as, for example, an auxiliary dryer for further promoting the drying of ink. The print heater 20, the preheater 22, and the after-heater 24 are not limited to being disposed inside the platen 14, and can be disposed, for example, on a mount provided in the vicinity of the medium 50.

The controller 30 is, for example, a CPU of the printing apparatus 10, and controls the operation of each portion of the printing apparatus 10. According to the present example, for example, printing on the medium 50 can be appropriately performed using the instant-drying type ink. Furthermore, a specific configuration of the printing apparatus 10 is not limited to the configuration illustrated in FIGS. 1A and 1B, and various modifications may be made. For example, the direction in which the head portion 12 performs the main scan may not be bidirectional, and may be only one direction parallel to the main scanning direction. In this case, for example, it is conceivable to dispose the ultraviolet light source 104 only at a position on the back side of the inkjet heads 102y to 102k in one direction (forward direction) in which the main scan is performed, and irradiate the ultraviolet light immediately after the ink lands on the medium 50 at the time of main scan in the forward direction.

In the description made above, an example of a serial type configuration in which the main scan and the sub scan are performed has been mainly described as a configuration of the printing apparatus 10. However, consideration is also made to use a configuration other than the serial type as the configuration of the printing apparatus 10. In this case, as a configuration other than the serial type, for example, it is conceivable to use various configurations in which the ultraviolet light source 104 is disposed on the downstream side of the inkjet head in the direction in which the medium 50 moves relative to the head portion 12 at the time of scanning in which the head portion 12 performs scanning of ejecting ink. The position of the ultraviolet light source 104 can also be considered as, for example, the downstream side in the printing direction by the head portion 12 or on the downstream side in time series.

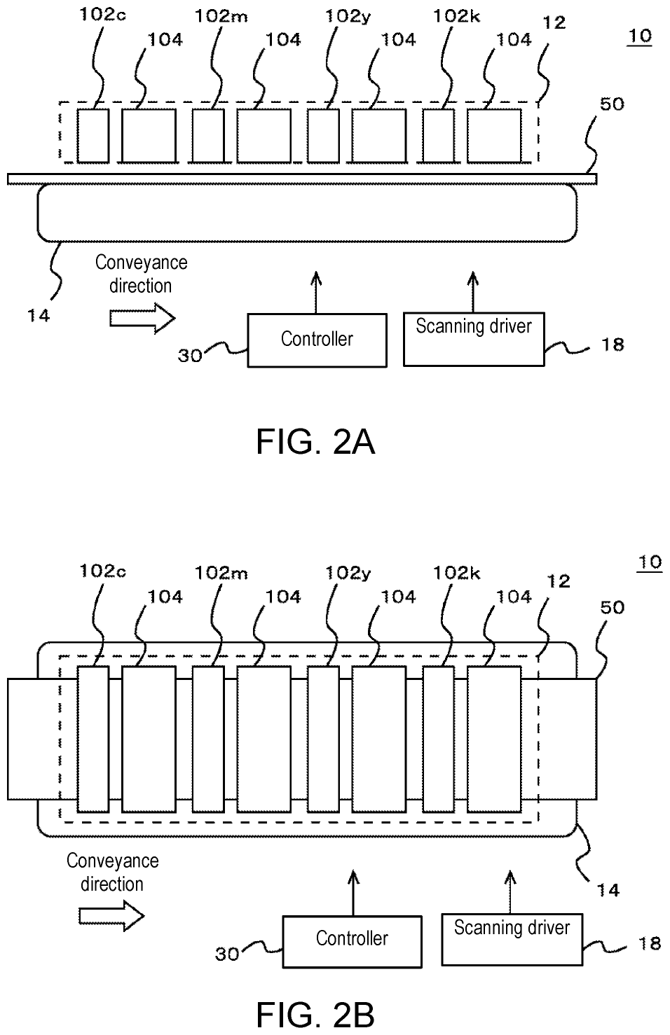

FIGS. 2A and 2B are views describing a modified example of the configuration of the printing apparatus 10. FIGS. 2A and 2B are respectively a side cross-sectional view and a top view showing an example of a configuration of a main part of the printing apparatus 10 in the present modified example in a simplified manner. Other than the points described below, in FIGS. 2A and 2B, the configuration denoted with the same reference numbers as FIGS. 1A and 1B may have features same as or similar to the configuration in FIGS. 1A and 1B.

In the present modified example, the printing apparatus 10 is a line printer that performs printing through a line method, and includes a head portion 12, a platen 14, a scanning driver 18, and a controller 30. The line printer is a printing apparatus in which a plurality of inkjet heads are arranged along a conveyance direction set in advance, and ink is sequentially ejected from the plurality of inkjet heads to the medium 50 being conveyed. Furthermore, the present modified example can be considered as, for example, an example of the configuration of the printing apparatus 10 that performs one-pass operation (one-pass printing) in which ink is ejected to each position of the medium 50 only once by each inkjet head.

Furthermore, more specifically, in the present modified example as well, the head portion 12 includes a plurality of inkjet heads and a plurality of ultraviolet light sources 104. As shown in the figure, the plurality of inkjet heads include inkjet heads 102c to 102k arranged in order along the conveyance direction. An ultraviolet light source 104 is provided at a position on the downstream side of each of the inkjet heads 102y to 102k in the conveyance direction. Moreover, each ultraviolet light source 104 thus irradiates with the ultraviolet light the ink ejected onto the medium 50 by the inkjet head immediately upstream in the conveyance direction before the ink is ejected by the next inkjet head. According to this configuration, for example, the ink ejected onto the medium 50 by each of the inkjet heads can be appropriately dried. In addition, the arrangement of the ultraviolet light source 104 in the present modified example can be considered as, for example, a configuration in which an ultraviolet irradiator for instant-drying is provided for each color (each color of CMYK) to use for printing.

Furthermore, in the present modified example, the platen 14 supports the medium 50 such that at least the inkjet heads 102c to 102k and the plurality of ultraviolet light sources 104 and the medium 50 face each other. The scanning driver 18 also conveys the medium 50 in the conveyance direction at a preset speed. Furthermore, in this case, the scanning driver 18 conveys the medium 50 without stopping the medium 50 at the position facing the inkjet heads 102c to 102k. Each of the inkjet heads 102c to 102k ejects ink of each color to the moving medium 50.

Here, when an evaporation-drying type ink other than the instant-drying type is used in a line printer, the medium 50 is usually heated by a heater disposed downstream (downstream side in the conveyance direction) of the inkjet head of each color to indirectly heat the ink. In this case, the temperature of the entire medium 50 rises. Then, in this case, if each position of the medium 50 is moved to the position of the next inkjet head while the temperature is still high, the inkjet head is heated by the influence of the heat received from the medium 50, and the nozzle clogging may easily occur. Therefore, in a case of using the evaporation-drying type ink in the conventional line printer, it is necessary to make the interval of the inkjet heads (interval in the conveyance direction) sufficiently large to secure a sufficient cooling period. On the other hand, in a case of using the instant-drying type ink, only the ink can be efficiently heated, so that the required cooling period can be significantly shortened. As a result, for example, the interval between the inkjet heads can be reduced, and downsizing of the printing apparatus 10 can be realized more appropriately.

Now, the features and the like of the ink to be used in each configuration described above will be described in more detail. First, the features of the instant-drying type ink will be described in more detail. In the following, for the sake of convenience of explanation, the present example is not limited to the printing apparatus 10 described with reference to FIGS. 1A and 1B and also includes a modified example of the printing apparatus 10 using the same ink.

First, regarding a case where an ink different from the present example is used, the method of fixing the ink and the like will be described for a case of using an evaporation-drying type ink other than the instant-drying type. As described above, when the evaporation-drying type ink other than the instant-drying type is used, the ink is usually heated indirectly by using a heater for heating the medium 50. More specifically, for example, in a serial type configuration, it is conceivable to use a print heater or the like disposed at a position facing the inkjet head. Then, in this case, the inkjet head always moves on the temperature-raised print heater while performing the printing operation. Therefore, in this case, when the temperature of the print heater is raised to a high temperature, the inkjet head is also heated, and the ink dried around the nozzle and the periphery of the nozzle is coagulated, which easily causes ejection failure. Therefore, it is usually necessary to set the temperature of the print heater in the range of about 40 to 60° C. In this case, when printing is performed at high speed, the drying speed of the ink cannot be in time, and smearing easily occurs. For example, when using a permeable medium 50 (permeable media) such as fabric or paper, the solvent in the ink penetrates to the inside of the medium 50 before the ink is dried, and the ink becomes more difficult to dry. Also, in this case, as the amount of ink remaining on the surface of the medium 50 decreases, it may be difficult to print a dark color.

Furthermore, even if the temperature of the heater is low, in order to increase the drying speed of the ink, it seems that, for example, a solvent having a low boiling point may be used as a solvent of the ink. However, in this case, since the ink before being ejected from the inkjet head is also easily dried, problems such as nozzle clogging more likely occur even in a state where the temperature of the heater is low. In addition, in the solvent having a low boiling point, the drying speed at normal temperature also becomes high. Therefore, nozzle clogging and ejection failure due to drying of the ink are likely to occur even at the time of standby or the like in which the printing operation is not performed. Thus, printing may not be appropriately performed by merely using a solvent having a low boiling point.

Furthermore, when a conventional normal evaporation-drying type ink is used, printing is usually performed through a multi-pass method in which the pass number is increased in order to prevent smearing and the like, so that it is necessary to reduce the density (landing density) of the ink landing in a unit area in a unit time. In this case, it becomes difficult to increase the printing speed due to the increase in the pass number. In a case where a conventional usual evaporation-drying type ink is used, even if printing is performed through such a multi-pass method, it may become necessary to use a low-boiling point organic solvent as the solvent depending on the application of printing. For example, in the case of a multi-pass wide format printer (MWP) or the like which performs large size and high definition printing in the field of sine graphics, an ink containing a low-boiling point organic solvent as a solvent is used. And, as such an organic solvent, a low boiling point solvent or the like which requires a toxicity indication that falls under the organic law is used.

On the other hand, as described above, in the present example, an instant-drying type ink is used. In this case, even when an ink containing a solvent having a high boiling point is used, for example, the ink can be appropriately dried in a short time without using a heater or the like for heating at a high temperature.

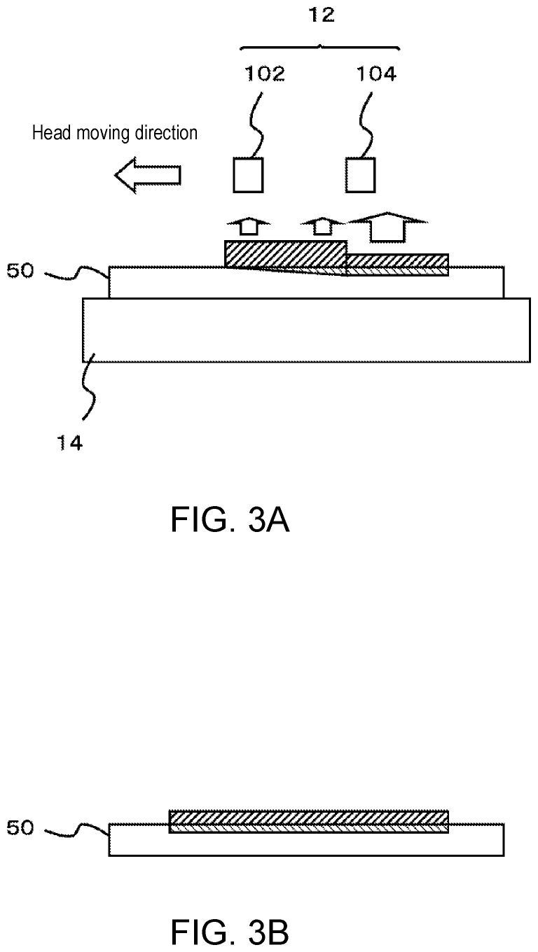

FIGS. 3A and 3B are views describing the features of using the instant-drying type ink in more detail. FIG. 3A is a view schematically showing an operation of drying the instant-drying type ink, and shows an example of a way the solvent in the ink evaporates at the time of main scan in the serial type configuration for a case where the permeable medium 50 is used. FIG. 3B is a cross-sectional view showing an example of a state of a medium 50 after the printing is completed.

As shown in FIG. 3A, when the main scan is performed in the serial type configuration, the head portion 12 including the inkjet head 102 and the ultraviolet light source 104 is used. The inkjet head 102 in the figure is a representative of one of the inkjet heads 102c to 102k shown in FIGS. 1A and 1B. In this case, as shown in the figure, the ink that landed on the medium 50 is irradiated with an ultraviolet light by the ultraviolet light source 104 located on the back side of the inkjet head 102 in the moving direction (head moving direction) of the head portion 12 at the time of the main scan. In this case, the solvent contained in the ink on the medium 50 gradually evaporates by being heated, for example, to a vapor pressure corresponding to room temperature or a temperature lower than the print heater 20 (see FIGS. 1A and 1B) in the platen 14 until being irradiated with ultraviolet light by the ultraviolet light source 104 after landing on the medium 50. In the meantime, a part of the ink penetrates into the medium 50.

However, thereafter, the ink is instantaneously heated by being irradiated with the ultraviolet light of the ultraviolet light source 104. As a result, the solvent in the ink evaporates rapidly. The rapid evaporation of the solvent in the ink also stops the penetration of the ink into the medium 50. Therefore, with this configuration, for example, the ink can be appropriately dried in a short time. This can appropriately prevent, for example, the occurrence of ink smearing. Furthermore, in this case, since the ink can be appropriately dried before the penetration of the ink into the medium 50 advances too much, for example, as shown in FIG. 3B, sufficient amount of ink can be appropriately remained on the surface of the medium 50. This allows, for example, printing of dark colors to be more appropriately performed.

Furthermore, in this case, as shown in FIG. 3A, the ultraviolet light source 104 moves away from the inkjet head 102 toward the back side in the head moving direction to irradiate the ink outside the position facing the inkjet head 102 with the ultraviolet light. In this case, even if the temperature of the ink becomes a high temperature, the radiant heat does not directly strike the inkjet head 102. Furthermore, as a result, it can be considered that the temperature of the inkjet head 102 is not substantially increased due to the irradiation of the ultraviolet light, and the ink is not dried at the nozzle or the periphery thereof due to the influence of the irradiation of the ultraviolet light. Therefore, in a case where the instant-drying type ink is used, the heating temperature of the ink can be appropriately and sufficiently raised. More specifically, the heating temperature of the ink by the irradiation of the ultraviolet light can be, for example, considered to be made to a temperature of greater than or equal to 80% (preferably greater than or equal to 90%) of the temperature at which the ink boils (boiling point of ink), and the like. In addition, the heating temperature of the ink may be, for example, higher than or equal to a temperature at which the ink boils. With this configuration, for example, the ink can be more appropriately dried in a short time. In a case where the instant-drying type ink is used, the ultraviolet lights are absorbed only by the ink, so that the energy consumption can be sufficiently reduced even when the temperature of the ink is raised. Therefore, the temperature of the periphery of the ultraviolet light source 104 and the inside of the printing apparatus 10 is less likely to rise excessively.

Thus, the ink can be efficiently dried in a short time by using the instant-drying type ink. Further, in this case, the smearing and the like can be appropriately prevented not only when the permeable medium 50 is used, but for example, even when an impermeable medium 50 is used. Thus, for example, the printing can be more appropriately performed even with respect to the medium 50 which has conventionally been difficult to use due to the large problem of smearing. More specifically, as the instant-drying type ink, for example, it is conceivable to use an ink obtained by adding an ultraviolet light absorber to a conventional evaporation-drying type ink such as a solvent ink, an aqueous ink, or a latex ink. In this case, the solvent ink is an ink in which an organic solvent is used as a solvent. The aqueous ink is an ink in which an aqueous solvent such as water is used as a solvent. The latex ink is an ink in which a latex resin is dispersed in a solvent such as water. In this case, the printing can be more appropriately performed even with respect to, for example, the medium 50 which could not be used in combination with the conventional ink, by adopting the instant-drying type ink for the ink.

Here, in the description made above, the problem that occurs in the serial type configuration has been mainly described as the problem that occurs when the evaporation-drying type ink other than the instant-drying type is used. On the other hand, the temperature of the heater can be raised by disposing a heater avoiding a position facing the inkjet head by using, for example, a line type configuration. Furthermore, in this case, the smearing of ink, and the like can be appropriately prevented without using, for example, an organic solvent having a low boiling point. However, in this case, as described above, it is conceivable that problems such as increase in size of the printing apparatus 10 may occur. On the other hand, as described above with reference to FIGS. 2A and 2B and the like, when the instant-drying type ink is used, the interval between the inkjet heads is reduced so that downsizing of the printing apparatus 10 and the like can be more appropriately realized. Therefore, it is extremely useful to use the instant-drying type ink in the line-type configuration as well.

Next, the features of the instant-drying type ink to be used in the present example will be described in more detail. As described above, in a case where the instant-drying type ink is used, the ink can be efficiently dried in a short time. Therefore, even when a solvent having a high boiling point is used as a solvent of the ink, the ink can be appropriately dried before smearing occurs. Therefore, in the present example, an organic solvent having a high boiling point that does not fall under the organic law (low toxicity organic solvent that does not fall under the organic law) is used as the solvent of the ink. The solvent of the ink to be used in this example can be considered as, for example, an odorless and safe solvent.

More specifically, the ink to be used in the present example contains, as at least a part of the solvent, a main solvent which is a component of a liquid that accounts for greater than or equal to 30% by weight ratio of the entire ink. Furthermore, as the main solvent, one or more mixtures selected from, for example, an organic solvent of normal paraffins, an organic solvent of isoparaffins, an organic solvent of naphthenes, an organic solvent of alkylbenzenes, and an organic solvent of olefins are used. Moreover, in this case, it is conceivable to select and use one having a boiling point of higher than or equal to 100° C. among these organic solvents. More specifically, in the present example, an organic solvent that does not fall under the organic law (organic solvent that does not covered by the organic law) is used as the organic solvent. With this configuration, an organic solvent with a small load on the human body and the environment can be appropriately used as a main solvent of the ink. Moreover, in this case, the safety of the ink can be more appropriately improved by using an organic solvent not corresponding to the organic law. Furthermore, even in a case where such an organic solvent is used, the ink can be more appropriately dried by using the instant-drying type ink.

Here, in the present example, the main solvent of the ink is a component having the largest weight ratio among the liquid components contained in the ink before being ejected from the inkjet head. Furthermore, the weight ratio of the main solvent with respect to the entire ink is preferably greater than or equal to 50%, and more preferably greater than or equal to 70%. The ink may further contain liquid components other than the main solvent. Moreover, a mixed solvent which consists of a plurality of organic solvents may be used as the main solvent. Furthermore, only one organic solvent may be used as the main solvent. In this case, it is conceivable to use, as the main solvent, any of an organic solvent of normal paraffins, an organic solvent of isoparaffins, an organic solvent of naphthenes, an organic solvent of alkylbenzenes, or an organic solvent of olefins.

Among the above-listed organic solvents, one or more mixtures selected from an organic solvent of isoparaffins, an organic solvent of naphthenes, and an organic solvent of alkylbenzenes, in particular, are preferably used as the main solvent of the ink. Furthermore, the main solvent preferably contains, for example, an organic solvent having a boiling point of higher than or equal to 100° C. by greater than or equal to 50% by weight ratio with respect to the entire ink. Moreover, the main solvent further preferably contains, for example, an organic solvent having a boiling point of higher than or equal to 150° C. by greater than or equal to 50% by weight ratio with respect to the entire ink. With this configuration, the safety of the ink can be more appropriately improved.

Furthermore, such an instant-drying type ink can be considered as, for example, a solvent ink type ink in which an organic solvent is used as a main agent. In the following, such instant-drying type ink is referred to as a first ink type. Moreover, the solvent which consists of an organic solvent that does not fall under the organic law as described above can also be considered as, for example, an eco-solvent with small load to environment and the like. The boiling point of the main solvent of the first ink type may be determined according to the purpose of use. In this case, to determine the boiling point of the main solvent means, for example, to determine the organic solvent to be used and the mixing ratio of the organic solvent in accordance with the desired boiling point. In this case as well, if the boiling point of the main solvent is too low, nozzle drying is likely to occur as described above. On the other hand, if the boiling point of the main solvent is too high, the drying may be insufficient even when the instant-drying type ink is used. On the other hand, when the above-mentioned organic solvent is used, the ink can be appropriately dried in a short time while preventing the occurrence of such a problem. Furthermore, when considered in a more general manner, it is considered preferable to set the boiling point of the main solvent of the ink to, for example, higher than or equal to about 100° C. and lower than or equal to about 300° C.

With regard to the organic solvent used as a component of the main solvent of the ink, more specifically, as the organic solvent of normal paraffins, for example, normal paraffin SL, normal paraffin L, normal paraffin M, or normal paraffin H and the like can be considered for use. As the organic solvent of isoparaffins, for example, it is conceivable to use isohexane, isosol 200, isosol 300, isosol 400 or the like. As the organic solvent of naphthenes, for example, it is conceivable to use naphthesol LL, naphthesol L, naphthesol M, naphthesol H, naphthesol MS-20 or the like. As the organic solvent of alkylbenzenes, for example, it is conceivable to use Hysol E, Hysol F, Alken 56N, Alken 60NH, Alken L, Alken 201, Alken 22, Alken 100P, Alken 68, Alken 200P, nonylbenzene or the like. Moreover, as the organic solvent of olefins, it is conceivable to use crude nonene, dodecene, 56N polymer, high mass polymer or the like.

In the present example, the ink may further contain, for example, a component same as or similar to the known ink, in addition to the components described above. More specifically, the ink may further contain, for example, a coloring material corresponding to the color of the ink, a binder resin, various additives, and the like. Furthermore, as the additive, for example, it is conceivable to use an additive for adjusting the viscosity, the contact angle, and the like of the ink. Moreover, as such an additive, for example, it is conceivable to use a known thickening agent, alcohol, and the like. These components are contained in the ink, for example, by being dissolved or dispersed (mixed) in the main solvent of the ink.

Here, for example, when using a low-boiling point organic solvent as a main solvent in a known solvent ink, a plastic medium 50 or the like is usually used. In this case, the adhesion of the ink is enhanced by attacking the surface of the medium 50 by the low-boiling point organic solvent. On the other hand, when using the above-mentioned high-boiling point organic solvent, it is conceivable that the adhesion lowers because the action of attacking the medium 50 is substantially eliminated. Therefore, in such a case, the adhesion of the ink is assumed to be enhanced by containing the binder resin in the ink as described above. In this case, the binder resin can be considered, for example, as a resin remaining on the medium 50 even after the ink is dried. By using such an ink, the ink can be more appropriately fixed on the medium 50. Furthermore, in this case, for example, it is conceivable to use a resin same as or similar to a known binder resin capable of obtaining high adhesion as the binder resin. More specifically, for example, in a case where an impermeable plastic medium 50 or the like is used, a urethane resin, an acrylic resin, or the like can be suitably used as the binder resin.

When using a high-boiling point organic solvent as the main solvent as in the first ink type, it is preferable not to use a low-boiling point organic solvent as a component of a liquid other than the main solvent. More specifically, in this case, it is preferable not to use a low-boiling point organic solvent as a component of the liquid that accounts for some extent or more with respect to the entire ink. In this case, the component of the liquid that accounts for some extent or more with respect to the entire ink is, for example, a component of the liquid that accounts for greater than or equal to 10% (preferably, greater than or equal to 5%) by weight ratio to the entire ink. The low-boiling point organic solvent is, for example, an organic solvent having a boiling point of lower than or equal to 80° C. (preferably lower than or equal to 70° C.).

Moreover, in order to improve the safety of the ink, it is also conceivable to use, for example, an ink containing water as a main solvent. Hereinafter, such an instant-drying type ink will be referred to as a second ink type. In the second ink type, it is also conceivable to use a sub-solvent as a component of the solvent, other than the main solvent. In this case, the sub-solvent is, for example, a component of a liquid having a smaller weight ratio than the main solvent in the components of the solvent of the ink. Furthermore, the content of the sub-solvent in the ink is, for example, greater than or equal to 5% (preferably greater than or equal to 10%) by weight ratio with respect to the entire ink. Moreover, the sub-solvent may be, for example, a liquid having the second largest content after the main solvent among the liquid components of the ink. As the sub-solvent, it is conceivable to use one or more mixtures selected from, for example, an organic solvent of normal paraffins, an organic solvent of isoparaffins, an organic solvent of naphthenes, an organic solvent of alkylbenzenes, and an organic solvent of olefins. Moreover, in this case, it is conceivable to select and use an organic solvent which has a boiling point of higher than or equal to 100° C. and does not fall under the organic law among these organic solvents. More specifically, as such a sub-solvent, the liquid same as or similar to the main solvent (eco-solvent) in the first ink type described above can be suitably used. In this configuration as well, the safety of the ink can be appropriately improved.

Furthermore, in a case where the instant-drying type ink of such a second ink type is used, it is conceivable to perform ultraviolet irradiation in two-stages by using a sub-solvent having a boiling point higher than that of water. More specifically, in this case, it is conceivable to irradiate water, which is the main solvent, by the first irradiation of ultraviolet light, and then, after a predetermined time has elapsed, irradiate the ultraviolet light again to completely dry the ink. With this configuration, for example, the occurrence of smearing can be appropriately prevented by increasing the viscosity of the ink by the first irradiation of ultraviolet light performed at an early timing after landing. Furthermore, in this case, for example, the dots of the ink can be appropriately flattened until the irradiation of the ultraviolet light for completely drying the ink is performed. More specifically, when printing is performed in the printing apparatus 10 having the serial type configuration, it is conceivable to use the ultraviolet light source 104 (see FIGS. 1A and 1B) in the head portion 12 for the first irradiation of the ultraviolet light. It is also conceivable to perform the subsequent irradiation of the ultraviolet light using, for example, the other ultraviolet light source disposed exterior to the head portion 12. Furthermore, it is conceivable that the irradiation of the ultraviolet light performed to completely dry the ink is performed with a stronger intensity than the first irradiation of the ultraviolet light.

Furthermore, as such a second ink type, for example, the aqueous latex ink or the like which is an instant-drying type can be suitably used. In this case, for example, the addition of a high-boiling point sub-solvent enables the two-stage irradiation of the ultraviolet light as described above, thus promoting the flattening of the ink dots and appropriately enhancing the smoothness before the ink is completely dried.

Next, the ultraviolet light absorber used in the instant-drying type ink will be described in more detail. As described above, in the instant-drying type ink, for example, an ultraviolet light absorber that generates heat by absorbing ultraviolet light is added to cause the ink to generate heat according to the ultraviolet light. Moreover, as such an ultraviolet light absorber, various known ultraviolet light absorbers can be used. Furthermore, as a known ultraviolet light absorber, for example, an ultraviolet light absorber of an organic substance, and the like can be used.

However, in a case where the ultraviolet light absorber is added to the ink, it is preferable to use a more highly safe substance also for the ultraviolet light absorber and the like in order to improve the safety of the ink more appropriately. More specifically, in this case, for example, it is conceivable to use a predetermined metal oxide or the like. As such a metal oxide, for example, it is conceivable to use one or more substances selected from zinc oxide (ZnO), titanium oxide (TiO₂), cerium oxide (CeO₂), and iron oxide (Fe₂O₃). When an ultraviolet light absorber of such a metal oxide is used, the influence on the environment, the human body, and the like can be more appropriately suppressed, as compared with the case where the ultraviolet light absorber of an organic substance is used. Furthermore, in this case, for example, the stability of the ultraviolet light absorber can be enhanced. More specifically, in a case where the instant-drying type ink is used, it is conceivable that the temperature of the ink temporarily rises to a high temperature by irradiating ultraviolet light. Therefore, when using the ultraviolet light absorber of the organic substance, a part of ultraviolet light absorber may evaporate with the solvent, and become a cause of an odor, and the like. In addition, it is conceivable that the ultraviolet light absorber is decomposed when the temperature of the ink becomes high, and an unintended substance (e.g., radical etc.) is generated. As a result, this may affect the environment and the human body.

On the other hand, the ultraviolet light absorber of the metal oxide as described above is considered to have extremely high stability at high temperature as compared to the organic substance. Therefore, when such an ultraviolet light absorber is used, evaporation or decomposition of the ultraviolet light absorber does not easily occur even if the ink temporarily becomes a high temperature. As a result, even if the ink temporarily becomes a high temperature, it is considered that the occurrence of problems such as odor and the generation of unintended substances and the like do not substantially occur. Further, it is considered that the ultraviolet light absorber of the metal oxide as described above is superior to the organic substance in the stability after fixing of the ink. More specifically, in a case where the ultraviolet light absorber of the metal oxide as described above is used, the function of absorbing the ultraviolet light can be maintained for a long period of time even after completion of printing. Thus, for example, the weather resistance (light resistance) of the printed matter can also be improved. Furthermore, in a case where the ultraviolet light absorber of the metal oxide is used, for example, a configuration in which the temperature is easily propagated through the ink can be realized. Therefore, with such a configuration, for example, the ink can also be heated more appropriately at the time of irradiation of the ultraviolet light.

The addition amount (total addition amount) of the metal oxide used as the ultraviolet light absorber is preferably about 0.1 to 15% by weight ratio with respect to the entire ink. The addition amount of the metal oxide is preferably about 1 to 10%. Furthermore, when the size of the metal oxide used as the ultraviolet light absorber is too large, it may become difficult to eject from the nozzle of the inkjet head, or precipitation of the metal oxide may easily occur in the ink before the ejection. Moreover, when the size of the metal oxide is large, the light transmittance of the ink may lower. Therefore, the average particle size of the metal oxide used as the ultraviolet light absorber is preferably smaller than or equal to about 1 μm. Furthermore, the average particle size of the metal oxide is more preferably smaller than or equal to 300 nm. Moreover, as a metal oxide used as an ultraviolet light absorber, it is possible to use a powder form having such a particle size.

Furthermore, as an UV LED used for the ultraviolet light source 104, for example, it is preferable to use an ultraviolet irradiator (UV irradiator) capable of irradiating an ultraviolet light having a wavelength of less than or equal to 410 nm (preferably less than or equal to 390 nm). More specifically, as such a UV LED, it is conceivable to use an UV LED having a wavelength of the center of light emission at about 365 nm (e.g., about 330 to 410 nm, preferably about 350 to 390 nm). In this case, it is preferable to use a substance having an absorption edge at a wavelength of less than or equal to 390 nm (e.g., about 330 to 400 nm) as the ultraviolet light absorber. Furthermore, in this case, the ultraviolet light generated by the UV LED can be appropriately absorbed by using the metal oxide described above. Thus, for example, the energy of the ultraviolet light irradiated by the ultraviolet light source 104 can be appropriately converted to heat energy, and the ink can be heated selectively and directly. Furthermore, in this case, for example, the ultraviolet light having a wavelength of about 365 nm can be absorbed particularly efficiently by using zinc oxide (ZnO) among the above-mentioned metal oxides.

Furthermore, as the ultraviolet light absorber, it is usually preferable to use a colorless and highly transparent substance in the visible light region. For example, zinc oxide selectively absorbs ultraviolet light and does not have significant absorption characteristics in the visible light region, and thus it can appropriately prevent the occurrence of color turbidity and the like in the ink. Moreover, this allows clear and highly safe color printing and the like to be performed, but it is conceivable to use an ultraviolet light absorber exhibiting a predetermined color depending on the color of the ink. More specifically, for example, it is also conceivable to use Fe₂O₃, which is a substance exhibiting black, as an ultraviolet light absorber for black ink.

Furthermore, the metal oxide as described above can be considered as a substance having a small influence on the human body. More specifically, zinc oxide is a substance which is also used, for example, in cosmetics and the like, and can be regarded as a substance substantially harmless to the human body. In addition, the other metal oxides described above can also be considered as substances that are highly safe for the human body. Therefore, when such a metal oxide is used as an ultraviolet light absorber, the printing apparatus 10 (see FIGS. 1A and 1B) can be used for more various applications by using a highly safe substance having a sufficiently small load on the human body for other components (solvent etc.) of the ink. More specifically, in this case, for example, printing on a food by the printing apparatus 10 may be considered. Furthermore, for example, printing on a food packaging, toys, clothing, and the like may be considered.

Furthermore, such metal oxides do not produce odor. Therefore, this point can also be considered as being suitable for applications such as a food. Moreover, when using a zinc oxide and a titanium oxide as a metal oxide, it is conceivable to take advantage of the bactericidal property of these substances in the application of a food and the like. Furthermore, in a case of applications where high safety is particularly required, such as a food, it is preferable to use water as the main solvent of the ink rather than the organic solvent. In this regard, when using water as the main solvent of the ink to improve safety and using a food as the medium to be printed, the smearing of the ink is particularly likely to occur due to the influence of the water contained in the food if the evaporation-drying type ink other than the instant-drying type is used. On the other hand, in a case where the instant-drying type ink is used, the occurrence of smearing can be appropriately suppressed even under such conditions.

Next, supplementary description and the like will be made regarding each configuration described above. Furthermore, in the following, for the sake of convenience of explanation, a case where the instant-drying type ink described above is collectively referred to as the present example. As described above, in the present example, a UV LED is used as the ultraviolet light source 104. Moreover, as UV LEDs, for example, known high-power UV LEDs can be suitably used. As such a UV LED, for example, a high-power InGaN-based UV LED manufactured by Nichia Chemical Co., Ltd. can be suitably used. Furthermore, the output energy of the ultraviolet light source 104 may be changed depending on, for example, the selection of the printing speed or the drying state. More specifically, the energy of the ultraviolet light irradiated by the ultraviolet light source 104 may be set to a value selected from the range of, for example, about 100 mJ/cm² to 10 J/cm². The time for irradiating each position of the medium 50 with ultraviolet light may be set to, for example, about 0.05 to 1 second according to the printing speed. Moreover, in this case, it is conceivable to increase the irradiation intensity as the irradiation time becomes shorter.

Furthermore, as described above, when the instant-drying type ink is used, only the temperature of the ink can be easily and instantaneously heated to a high temperature by causing the ink itself to generate heat. Furthermore, in this case, it is conceivable to raise the temperature of the ink, for example, to near or higher than or equal to the boiling point. In this regard, for example, when water is used as the solvent (main solvent) of the ink, a state of 20° C., which is a temperature around room temperature, and a state in which the temperature of the ink is raised to 100° C. are compared, where the evaporation speed of the ink is increased by greater than or equal to 40 times by temperature rise. Thus, by using the instant-drying type ink, the ink can be appropriately evaporated and dried in a short time of 1 second or less, for example, even when one layer of solid print is performed.

Furthermore, the loss of heat (heat loss) through the medium can be considered small when the instant-drying type ink is used. More specifically, for example, in a case where the instant-drying type ink is used, the ink can be instantaneously heated in a time sufficiently shorter than the time constant of heat radiation of the medium by controlling the irradiation time of the ultraviolet light. Therefore, in a case where a medium having a low thermal conductivity such as a plastic medium including vinyl chloride is used, the influence of heat radiation in the thickness direction of the medium can be ignored. More specifically, for example, assuming that the width in the main scanning direction of the ultraviolet light source 104 moving with the inkjet head 102 in the main scan is L, and the moving speed of the ultraviolet light source 104 in the main scan is v, the effective irradiation time Te, which is the time the ink on the medium is irradiated with ultraviolet light, is determined by the relationship of Te=L/v. Then, for example, when L=100 mm and v=500 mm/sec., Te=0.2 sec. On the other hand, the time constant (thermal time constant) τ of vinyl chloride having a thickness of 1 mm is about 10 seconds. Therefore, the relationship of τ>>Te is obtained by setting L to less than or equal to about 100 mm, and the influence of the heat radiation in the thickness direction of the medium can be ignored. As a result, only the ink (ink layer) on the medium can radiate heat rapidly and appropriately.

Furthermore, for example, when indirectly heating the ink by heating the medium with a heater, the temperature of the medium also needs to be heated to the same temperature in order to make the temperature of the ink near or higher than or equal to the boiling point. However, when water or an organic solvent having a boiling point of higher than or equal to 100° C. is used as the main solvent, it is usually difficult to heat the medium to such a temperature. In particular, when the heat resistance temperature of the medium is lower than the boiling point of the main solvent of the ink, it is difficult to raise the temperature of the ink to near or higher than or equal to the boiling point by the method of indirectly heating the ink. On the other hand, in a case where the instant-drying type ink is used, the ink can be appropriately heated to a high temperature even when the heat resistance temperature of the medium is low, and the like.

Furthermore, the position where the ultraviolet light source 104 is disposed is not limited to the configuration described above, and may be further changed according to the quality required for printing and the like. For example, in the printing apparatus 10 that performs printing through serial method, it is conceivable to dispose the ultraviolet light source 104 only at a position downstream of the inkjet head in the conveyance direction of the medium 50, and not on one side or both sides of the inkjet head in the main scanning direction. Moreover, as described above, in the instant-drying type ink, the ultraviolet light absorber absorbs the ultraviolet light. However, when a substance used in the ink (e.g., solvent, resin, coloring material, etc.) has the property of absorbing the ultraviolet light, the ink can be more efficiently heated by allowing also the substance to absorb the ultraviolet light. Furthermore, in this case, instead of adding a dedicated ultraviolet light absorber, other components may also have the function of the ultraviolet light absorber.

In addition, as described above, as the instant-drying type ink, an ink in which the solvent ink is an instant-drying type (instant-drying solvent ink), an ink in which the aqueous ink is an instant-drying type (instant-drying aqueous ink), ink in which the aqueous latex ink is an instant-drying type (instant-drying aqueous latex ink) or the like can be suitably used. Besides these, for example, an ink (instant-drying SUV ink) in which the solvent UV ink (SUV ink) which is an ink obtained by diluting the ultraviolet-curable ink with a solvent (organic solvent) is instant-drying type, an ink (instant-drying aqueous UV curable ink) in which an ultraviolet-curable ink containing water as the solvent is an instant-drying type or the like can be used. Furthermore, in this case, the instant-drying SUV ink and the instant-drying aqueous UV curable ink are inks that need to evaporate the solvent in the ink and the ink is not merely cured by the polymerization reaction. Therefore, these inks can also be considered as evaporation-drying type inks.

Furthermore, the color of the ink to use is not limited to the color described above, and various changes can be made. For example, as the chromatic color ink, in addition to the ink of each color of C, M, Y, it is also conceivable to further use the ink of each color of red color (R color), green color (G color), and blue color (B color). Furthermore, it is also conceivable to use an ink of a special color such as, for example, white, pearl, metallic, fluorescent, or phosphorescent color. Moreover, it is also conceivable to use a clear ink which is a clear color ink that does not contain a coloring material as an ink of a special color. It can be considered that the color of the ink to use in the printing apparatus 10 is not limited to a specific color, for example, as long as it is an ink of any one or more colors.

Furthermore, in consideration of using inks of various colors as described above, the timing of irradiating the ink on the medium 50 with an ultraviolet light for some colors may be different from other colors. For example, in a case where an overcoat layer is formed using a clear ink, and the like, it may be preferable to evaporate the solvent after leaving a certain amount of time after landing, rather than evaporating the solvent immediately after landing. Therefore, in such a case, the clear ink may be ejected in the main scan in the forward path in the reciprocating main scan, and the ultraviolet light may be irradiated in the main scan in the backward path. With this configuration, for example, the ink can be dried after waiting for the ink dots to be sufficiently flattened.

Furthermore, the medium 50 used in the printing apparatus 10 is not limited to the specific medium 50, and various media 50 can be used. More specifically, for example, it is conceivable to use various permeable medium 50 as the medium 50. Furthermore, as the permeable medium 50, it is considered to use, for example, a medium 50 of cloth (e.g., sewn product such as a T-shirt or a fabric), a medium 50 of paper, other porous medium 50, or the like. It is also conceivable to use an impermeable medium 50 such as a plastic film as the medium 50. As the impermeable medium 50, for example, it is conceivable to use a sheet of polyethylene terephthalate (PET), a sheet of polycarbonate (PC), a sheet of vinyl chloride, or the like. In addition, when using an instant-drying type ink, as described above, the occurrence of ink smearing can be appropriately prevented. Therefore, even in a case where, for example, the medium 50 that is not subjected to pretreatment for preventing smearing is used, the printing of high quality can be appropriately performed by the direct printing without the pretreatment (direct printing).

Furthermore, as described above, when a metal oxide such as zinc oxide is used as the ultraviolet light absorber, the stability of the ink after fixing can be enhanced. Moreover, as a result, the weather resistance of the printed matter can be enhanced by absorbing the ultraviolet light with the ultraviolet light absorber even after the printed matter is completed. Thus, such an instant-drying type ink can be particularly suitably used, for example, in a case where a printed matter to be installed outdoors or a printed matter that is required to have high weather resistance is printed. Moreover, as such a printed matter, for example, a printed matter in the field of sign graphics can be considered.

In the field of sign graphics and the like, the multi-pass wide format printer (MWP) has conventionally been used as described above. However, in the conventional MWP, the landing density of ink landing in a unit volume per unit time needed to be sufficiently reduced to prevent the occurrence of smearing. As a result, the operation in the multi-pass method in which the pass number is increased needs to be performed, and the speed of printing is decreased inversely proportional to the pass number, thus making high speed printing difficult to perform. On the other hand, when the instant-drying type ink is used, the occurrence of smearing can be appropriately prevented even when printing is performed with a smaller pass number. Thus, high speed printing can be more appropriately performed.

In the MWP, if the ink is not sufficiently dried, the ink image may be transferred to the back surface of the medium 50 when the medium 50 is wound after printing, or blocking phenomenon in which the adhesion occurs between the media 50 overlapped by the winding occurs, which greatly lowers the image quality of printing. Therefore, in the conventional MWP using a configuration in which the medium 50 is heated by the print heater, the organic solvent having a low boiling point that falls under the organic law needed to be used as the solvent of the ink in order to perform printing as fast as possible while preventing the shortage of the drying temperature and the drying time of the ink. On the other hand, when the instant-drying type ink is used, as described above, the ink can be appropriately dried even when using water or an organic solvent having a high boiling point as a main component (main solvent) or an auxiliary component (sub-solvent). Thus, for example, a highly safe ink can be more appropriately used in the MWP.

### INDUSTRIAL APPLICABILITY

The present disclosure can be suitably used in, for example, a printing apparatus.

What is claimed is:

1. A printing apparatus that performs a printing through an inkjet method, the printing apparatus comprising:
an inkjet head that ejects an ink; and
a heater that heats the ink ejected by the inkjet head,
wherein
the ink contains an energy ray absorber and a solvent, wherein the energy ray absorber is a substance that generates heat by absorbing an energy ray,
the heater evaporates at least a part of the solvent in the ink by irradiating the ink with the energy ray,
the ink contains, as at least a part of the solvent, a main solvent which is a component of a liquid that accounts for greater than or equal to 30% by weight ratio with respect to an entire of the ink, and
the main solvent is one or more mixtures selected from an organic solvent of normal paraffins, an organic solvent of isoparaffins, an organic solvent of naphthenes, an organic solvent of alkylbenzenes, and an organic solvent of olefins.

2. The printing apparatus according to claim 1, wherein
the main solvent is one or more mixtures selected from an organic solvent of isoparaffins, an organic solvent of naphthenes, and an organic solvent of alkylbenzenes.

3. The printing apparatus according to claim 1, wherein
the main solvent contains an organic solvent having a boiling point of higher than or equal to 100° C. by greater than or equal to 50% by weight ratio with respect to the entire of the ink.

4. The printing apparatus according to claim 1, wherein
the ink further contains a binder resin which is a resin that remains on a medium to be printed even after drying of the ink.

5. The printing apparatus according to claim 1, wherein
the energy ray is an ultraviolet light, and
the ink contains, as the energy ray absorber, one or more substances selected from ZnO, TiO₂, CeO₂, and Fe₂O₃.

6. The printing apparatus according to claim 5, wherein
the ink contains ZnO as the energy ray absorber.

7. The printing apparatus according to claim 2, wherein
the main solvent contains an organic solvent having a boiling point of higher than or equal to 100° C. by greater than or equal to 50% by weight ratio with respect to the entire of the ink.

8. The printing apparatus according to claim 2, wherein
the ink further contains a binder resin which is a resin that remains on a medium to be printed even after drying of the ink.

9. The printing apparatus according to claim 3, wherein
the ink further contains a binder resin which is a resin that remains on a medium to be printed even after drying of the ink.

10. A printing apparatus that performs a printing through an inkjet method, the printing apparatus comprising:
an inkjet head that ejects an ink; and
a heater that heats the ink ejected by the inkjet head,
wherein
the ink contains an energy ray absorber and a solvent, wherein the energy ray absorber is a substance that generates heat by absorbing an energy ray,
the heater evaporates at least a part of the solvent in the ink by irradiating the ink with the energy ray,
the ink contains, as at least a part of the solvent, a main solvent which is a component of a liquid that accounts for greater than or equal to 30% by weight ratio with respect to an entire of the ink, and a sub-solvent which is a component of a liquid having a smaller weight ratio than the main solvent,
the main solvent is water, and
the sub-solvent is one or more mixtures selected from an organic solvent of normal paraffins, an organic solvent of isoparaffins, an organic solvent of naphthenes, an organic solvent of alkylbenzenes, and an organic solvent of olefins.

11. A printing apparatus that performs a printing through an inkjet method, the printing apparatus comprising:
an inkjet head that ejects an ink; and
a heater that heats the ink ejected by the inkjet head,
wherein
the ink contains an energy ray absorber and a solvent, wherein the energy ray absorber is a substance that generates heat by absorbing an energy ray,
the heater evaporates at least a part of the solvent in the ink by irradiating the ink with the energy ray, and
the ink contains, as the energy ray absorber, one or more substances selected from ZnO, TiO₂, CeO₂, and Fe₂O₃.

12. The printing apparatus according to claim 11, wherein
the printing apparatus performs the printing on a food.
